(19) United States
(12) Patent Application Publication
(10) Pub. No.: US 2004/0124296 A1
(43) Pub. Date: Jul. 1, 2004

(54) Wet grinding and dispersion apparatus

(75) Inventors: Wang-Lin Liu, Taichung City (TW); Tzu-Chi Chan, Taichung Hsien (TW); Kuo-Yu Chien, Chia-Yi Hsien (TW)

Correspondence Address: RITTER, LANG & KAPLAN, 12930 SARATOGA AE. SUITE D1, SARATOGA, CA, 95070, US

(73) Assignee: PRECISION MACHINERY, Taichung City (TW)

(21) Appl. No.: 10/670,002

(22) Filed: Sep. 24, 2003

(30) Foreign Application Priority Data
Dec. 31, 2002 (TW) 091221667

(51) Int. Cl. B02C 1/08

(52) U.S. Cl. 241/277

(57) ABSTRACT

A wet grinding and dispersion apparatus includes a grinding chamber, a shaft, and a grinding wheel unit. The shaft is disposed rotatably in the grinding chamber. The grinding wheel unit is disposed in the grinding chamber, is mounted to rotate with the shaft, and includes a plurality of grinding wheels, each of which has opposite wheel surfaces. Each of the wheel surfaces is formed with stirring protrusions.

### BACKGROUND OF THE INVENTION

1. Field of the Invention

The invention relates to a wet grinding and dispersion apparatus, more particularly to a wet grinding and dispersion apparatus that is capable of obtaining a narrow particle size distribution in the micron particle size range.

2. Description of the Related Art

A conventional wet grinding and dispersion apparatus includes a grinding chamber, a shaft, a grinding wheel unit, and a motor.

The grinding chamber is filled with grinding beads and particles to be ground. The shaft is disposed rotatably in the grinding chamber and has a shaft axis. The grinding wheel unit is disposed in the grinding chamber, and includes a plurality of grinding wheels that are mounted to rotate with the shaft and that are disposed along the shaft axis. Each of the grinding wheels has opposite wheel surfaces and a periphery that interconnects the wheel surfaces. The periphery is formed with a groove unit. The groove unit includes a plurality of grooves that extend spirally relative to the center of the grinding wheel. The motor drives rotation of the shaft.

Although the conventional wet grinding and dispersion apparatus achieves its purpose of mixing the grinding beads and the particles together to grind the particles, the groove unit tends to generate current that flows in a fixed direction. As such, the particles may not be ground evenly, thereby resulting in a poor grinding effect. Moreover, the groove unit, due to its spiral shape, requires much effort to be formed, especially, when the grinding wheels are made from a hard material. As such, the grinding wheels can only be made from a material that has limited hardness so as to permit formation of the groove unit. Further, when the grinding beads are made from a material that is harder than that of the grinding wheels, the grinding wheels may wear out easily due to collision between the grinding wheels and the grinding beads.

### SUMMARY OF THE INVENTION

Therefore, the object of the present invention is to provide a wet grinding and dispersion apparatus that has a high grinding efficiency.

According to the present invention, a wet grinding and dispersion apparatus comprises a grinding chamber, a shaft, and a grinding wheel. The shaft is disposed rotatably in the grinding chamber. The grinding wheel unit is disposed in the grinding chamber, is mounted to rotate with the shaft, and includes a plurality of grinding wheels. Each of the grinding wheels has opposite wheel surfaces. Each of the wheel surfaces is formed with a plurality of stirring protrusions.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view to illustrate a shaft, a grinding wheel unit, and a locking unit of the preferred embodiment of a wet grinding and dispersion apparatus according to this invention; and

FIG. 2 is a schematic view of the shaft, the grinding wheel unit, and the locking unit of the preferred embodiment in an assembled state; and

FIG. 3 is a sectional view to illustrate a hole unit in the grinding wheel unit of the preferred embodiment.

### DETAILED DESCRIPTION OF THE PREFERRED EMBODIMENT

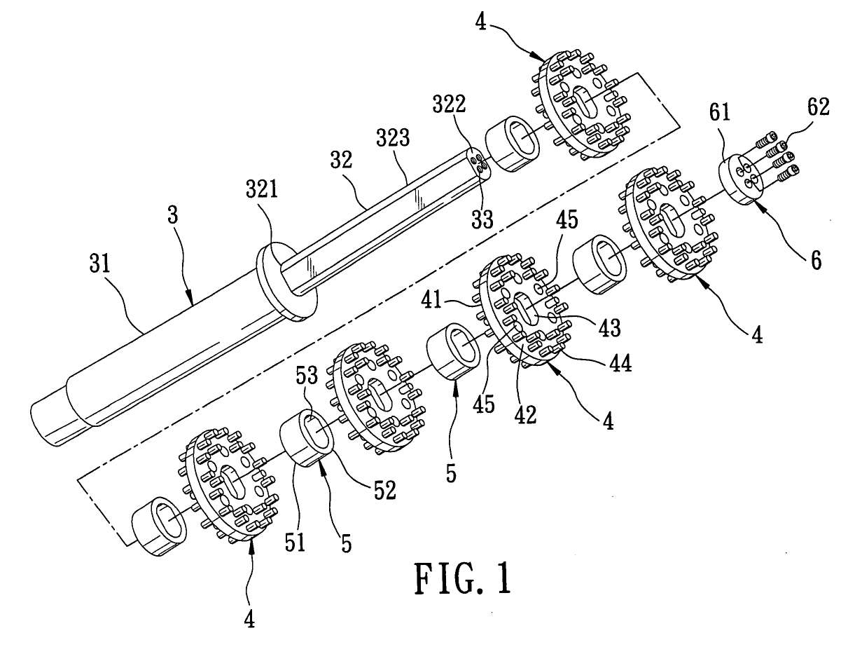

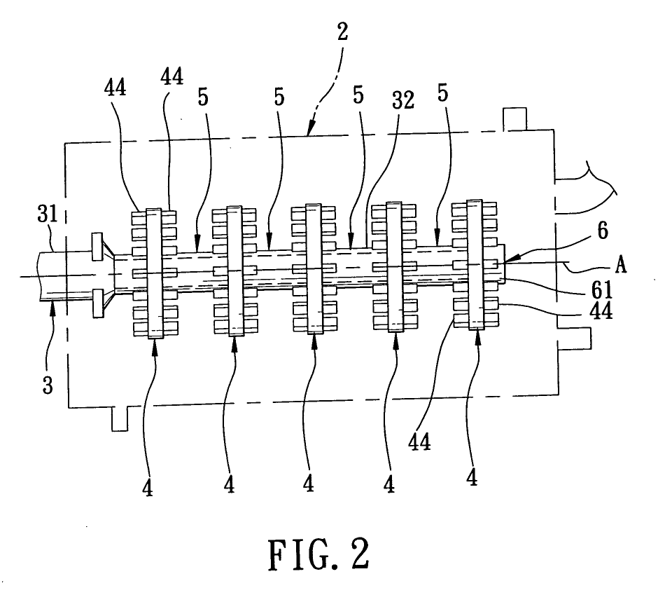

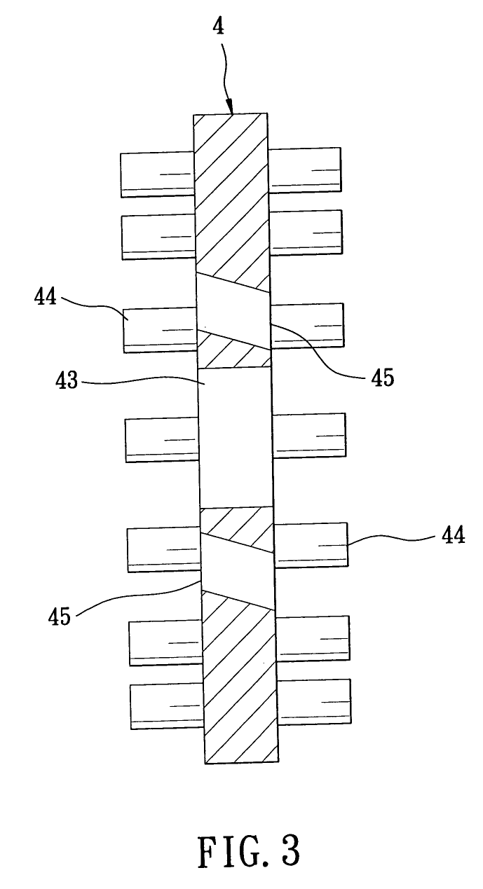

Referring to FIGS. 1 to 3, the preferred embodiment of a wet grinding and dispersion apparatus according to this invention is shown to include a grinding chamber 2, a shaft 3, and a grinding wheel unit.

The grinding chamber 2 is adapted to be filled with grinding beads (not shown) and particles (not shown) to be ground.

The shaft 3 is disposed rotatably and horizontally in the grinding chamber 2, and has a shaft axis (A). In particular, the shaft 3 has inner and outer sections 31, 32 disposed respectively inside and outside the grinding chamber 2. The inner section 32 of the shaft 3 has first and second ends 321, 322, and a middle portion 323 between the first and second ends 321, 322. The first end 321 of the inner section 32 of the shaft 2 is formed with a radially extending flange. The second end 322 of the inner section 32 of the shaft 3 is formed with four threaded holes 33, each of which extends parallel to the shaft axis (A). The middle portion 323 of the inner section 32 of the shaft 3 has a polygonal cross-section along a plane transverse to the shaft axis (A).

The grinding wheel unit is disposed in the grinding chamber 2, is mounted to rotate with the shaft 3, and includes five grinding wheels 4 and five spacers 5. Each of the grinding wheels 4 has opposite wheel surfaces 41, 42, and is formed with an axial hole 43 that extends through the wheel surfaces 41, 42 and that corresponds to the cross-section of the middle portion 323 of the inner section 32 of the shaft 3. Each of the spacers 5 has opposite spacer surfaces 51, 52, and is formed with an axial hole 53 that extends through the spacer surfaces 51, 52 and that corresponds to the cross-section of the middle portion 323 of the inner section 32 of the shaft 3. The grinding wheels 4 and the spacers 5 are sleeved co-rotatably on the shaft 3 in an alternating sequence such that one of the spacers 5 is proximate to the first end 321 of the inner section 32 of the shaft 3 and one of the grinding wheels 4 is proximate to the second end 322 of the inner section 32 of the shaft 3.

In this embodiment, each of the wheel surfaces 41, 42 is formed with a plurality of stirring protrusions 44, which are in the form of cylindrical pins in this embodiment. The spacers 5 serve to position spacedly the grinding wheels 4 on the shaft 3 so as to maintain an appropriate distance between the stirring protrusions 44 on adjacent ones of the grinding wheels 4. Furthermore, each of the grinding wheels 4 is formed with a hole unit. The hole unit includes six holes 45, each of which extends through the wheel surfaces 41, 42, is inclined with respect to the shaft axis (A), and is angularly displaced from an adjacent one of the holes 45.

The wet grinding and dispersion apparatus further comprises a locking unit 6 for retaining the grinding wheel unit on the shaft 3. In this embodiment, the locking unit 6 includes an end cap 61 that is fastened on the second end 323 of the inner section 32 of the shaft 3 and that abuts against the grinding wheel unit. The end cap 61 is formed with four holes therethrough, each of which is aligned with one of the threaded holes 33 in the second end 322 of the inner section 32 of the shaft 3. Four screw fasteners 62 are inserted respectively through the holes in the end cap 61 and are threaded respectively into the threaded holes 45.

From the above description, when the shaft 3 is rotated in a known manner, this results in rotation of the grinding wheels 4. Rotation of the grinding wheels 4 permits the stirring protrusions 44 to mix the particles and the grinding beads together. Moreover, rotation of the grinding wheels 4 permits the holes 45 to generate current to circulate the grinding beads and the particles. As such, the particles can be evenly ground and dispersed, thereby resulting in a high grinding efficiency. Further, rotation of the grinding wheels 4 permits the stirring protrusions 44 to violently collide with the grinding beads to result in higher impinging and shearing forces. As such, particles with size in the order of micron can be obtained.

Additionally, the stirring protrusions 44 are relatively easy to construct. The grinding wheels 4, therefore, can be made from a material that is harder than that of the grinding beads. As such, the grinding wheels 4 are not easily damaged by the grinding beads.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A wet grinding and dispersion apparatus comprising:
a grinding chamber;
a shaft disposed rotatably in said grinding chamber; and
a grinding wheel unit disposed in said grinding chamber, mounted to rotate with said shaft, and including a plurality of grinding wheels, each of which has opposite wheel surfaces, each of said wheel surfaces being formed with a plurality of stirring protrusions.

2. The wet grinding and dispersion apparatus as claimed in claim 1, wherein said shaft has a shaft axis, each of said grinding wheels being formed with a hole unit that extends through said wheel surfaces and that is inclined with respect to said shaft axis.

3. The wet grinding and dispersion apparatus as claimed in claim 1, wherein said grinding wheel unit further includes a plurality of spacers for positioning spacedly said grinding wheels on said shaft so as to maintain an appropriate distance between said stirring protrusions on adjacent ones of said grinding wheels.

4. The wet grinding and dispersion apparatus as claimed in claim 3, wherein said grinding wheels and said spacers are sleeved co-rotatably on said shaft, said apparatus further comprising a locking unit for retaining said grinding wheel unit on said shaft.

5. The wet grinding and dispersion apparatus as claimed in claim 4, wherein said locking unit includes an end cap fastened on one end of said shaft and abutting against said grinding wheel unit.
